(19) United States
(12) Patent Application Publication
(10) Pub. No.: US 2026/0054940 A1
(43) Pub. Date: Feb. 26, 2026

(54) Method for performing a container inspection task in a container treatment plant and container inspection apparatus for a container treatment plant

(71) Applicant: KRONES AG, Neutraubling (DE)

(72) Inventors: Alexander HEWICKER, Wörth an der Donau (DE); Max MEIERHOFER, Regenstauf (DE)

(21) Appl. No.: 19/308,091

(22) Filed: Aug. 22, 2025

(30) Foreign Application Priority Data
Aug. 22, 2024 (DE) 10 2024 124 076.8

(51) Int. Cl. B65G 43/08; B65G 49/00

(52) U.S. Cl. CPC B65G 43/08; B65G 49/00; B65G 2201/0235; B65G 2203/042

(57) ABSTRACT

Disclosed is a method for performing a container inspection task in a container treatment plant for treating a plurality of container parts for containers, in which a transport device transports the plurality of container parts as a container part stream along a predetermined transport path from at least one treatment device of the container treatment plant to at least one further treatment device of the container treatment plant and at least one sensor device for performing the container inspection task captures, in particular spatially resolved, sensor data, preferably camera images, with regard to the container parts to be inspected, and a real-time evaluation device evaluates the, spatially resolved, sensor data, in real time.

### CROSS REFERENCE OF RELATED APPLICATIONS

The present application claims benefit to German Patent Application Serial no. 10 2024 124 076.8, filed Aug. 22, 2024, the contents of which are incorporated herein by reference.

### BACKGROUND OF THE INVENTION

The present invention relates to a method for performing a container inspection task in a container treatment plant for treating a plurality of container parts (such as the container itself or a container closure) for containers, preferably plastic containers and/or bottles. In the container treatment plant, a transport device transports the plurality of container parts (to be inspected) as a container part stream along a predetermined transport path from at least one (first) treatment device of the container treatment plant to at least one further treatment device of the container treatment plant.

Furthermore, at least one sensor device for performing the container inspection task captures, in particular spatially resolved, sensor data, such as camera images, with respect to the container parts to be inspected. These captured sensor data are evaluated in real time by a real-time evaluation apparatus.

The present invention further relates to a container inspection apparatus for a container treatment plant and a method for determining container part features.

The containers are preferably plastic containers (in particular PET containers), containers whose main component consists of pulp and/or glass containers and/or cans. The containers may be containers from the beverage and/or food and/or cosmetics industries. For example, they can be cans or bottles, such as glass bottles, pulp bottles and plastic bottles.

In container treatment plants, such as container filling plants, a wide variety of sensors and image processing systems are used for process monitoring purposes, for example. For various process steps, such as injection molding, container cleaning, filling, labeling, closing, packing, strapping and/or shrink packaging, an optical inspection is subsequently performed to check and/or control or regulate a process.

For each process step, monitoring systems, usually image processing systems, are usually installed, which need configuring and are complex to parameterize. This requires a great deal of experience and sensitivity.

Currently, two types of image classifiers are used in inspection technology.

Firstly, classical classification methods are known that perform a classification based on a few features extracted from the image using algorithms, such as support vector machines, k-nearest neighbor or decision trees.

Secondly, modern, AI-based (artificial-intelligence-based) classification methods are known, which are mostly based on a neural network. The neural network is often used in the form of a convolutional neural network. The classifiers already contain a learned feature extraction that works particularly well but is immutable.

Classical classification methods require upstream feature extraction, which reduces the data from the image to few extracted features. The features are often selected and extracted “by hand”. The decision quality of the classifier is severely limited due to the significant reduction of the data and the limited performance of the classification algorithms.

Modern AI classifiers learn the extraction of the relevant features from the image and adapt very well to the task through the learning process. They achieve excellent decision quality in image classification. The disadvantages, however, are the long learning process and the high demand for learning data. This makes it impossible to quickly adapt to changing tasks (e.g., new types of bottles in the image).

The present invention has the object of overcoming the disadvantages known from the prior art and providing a method for performing a container inspection task in a container treatment plant and a container inspection apparatus for a container treatment plant, which can be quickly adapted to new inspection tasks and at the same time offers a very high inspection performance.

### SUMMARY OF THE INVENTION

In a method according to the invention for performing a container inspection task in a container treatment plant for treating a plurality of container parts for containers, preferably plastic containers and/or bottles, a transport device in the container treatment plant transports the plurality (to be treated and/or treated) of container parts (to be inspected) as a container part stream along a predetermined transport path from at least one (first) treatment device of the container treatment plant to at least one further treatment device of the container treatment plant.

The containers are preferably plastic containers (in particular PET containers), containers whose main component consists of pulp and/or glass containers and/or cans. The containers may be containers from the beverage and/or food and/or cosmetics and/or pharmaceutical industries. For example, they can be cans or bottles, such as glass bottles, pulp bottles and plastic bottles.

A “container part for a container” can also be understood to mean the container itself. For example, the container part could be a preform from which the fully formed container is produced through a forming process, or it could be the already fully formed container.

The container part for a container can also be an equipment item of the container, such as a (preferably resealable) container closure (e.g., screw closure or cap), a (PET and/or plastic) lid, a label, a (laser or direct print) marking, a filling material and/or packaging of the (finished) container, a container assembly or the like (as well as combinations thereof).

For example, the transport device can be a supplier (e.g., a supply rail) for container closures, which supplies the container closures from a collecting device to a closing device for closing containers.

Preferably, the container part is an object that can be transported as (precisely one) unit and is transported (independently of other transported container parts) by the transport device.

Preferably, the (first) treatment device and/or the (at least one) further treatment device (in particular each) performs at least one treatment step on the container part (and preferably on the container).

The treatment step of the (first) treatment device and/or the (at least one) further treatment device can be selected from a group of treatment steps, which include an injection molding process for producing an injection-molded part (e.g., a plastic preform), a cleaning process, a comminution process and/or division process (e.g., as part of a recycling process), a forming process (in particular, (stretch) blow molding), a (laser) marking process, an individualization process (e.g., applying a QR code), a rejection process (in which the container part is rejected from the container part stream of the container treatment plant), a sorting process (in which the container parts are sorted according to type), a filling process, a closing process, an (in particular, direct) printing process, a labeling process, laser decoration, a packaging process (in particular, applying primary and/or secondary packaging, such as welding several containers as a package and/or as a unit), a determination of the composition of substances or mixtures of substances, such as the atmosphere and/or air in or on a container part and preferably container, for example by a mass spectrometer and/or an odor sensor device, and the like, as well as combinations thereof.

Furthermore, at least one sensor device for performing the container inspection task (preferably container-part-specifically) captures, in particular spatially resolved, sensor data relating to the container parts to be inspected.

Preferably, at least regions of the container part to be inspected are imaged in the sensor data, preferably the container part region thereof that is observable or visible from at least one observation direction.

It is conceivable that sensor data are captured or collected individually for each container part to be inspected or for each container part individually (in a separate capturing step of the sensor device).

Exactly one sensor device can be provided which captures the sensor data required to perform the container inspection task with regard to the container parts. However, it is also conceivable that several sensor devices are provided for this purpose, which, for example, capture the sensor data from several recording directions in relation to the container part and/or which, in a multi-lane transport area, capture the container parts transported on different lanes.

The sensor data are preferably spatially resolved sensor data, which in particular depict a property to be captured (such as color value and/or gray value and/or brightness value) of an area of the container part. Preferably, the spatially resolved sensor data specify a sensor data curve as a function of at least one spatial and/or geometric coordinate and preferably as a function of at least two spatial and/or geometric coordinates (or are specifiable).

The sensor data can be, for example, a color value and/or gray value and/or brightness value, such as the sensor data captured by a camera.

The sensor data captured by a LIDAR device can be RGB values and/or intensity values, which are captured and stored for each captured data point together with or depending on its X, Y and Z position value.

It is also conceivable that the sensor data are frequency-resolved sensor data.

For example, at least one intensity value can be captured for each sensor data point as a function of a frequency of the radiation detected by the sensor device, so that the sensor data indicate a sensor value curve as a function of a frequency.

It is also conceivable that the sensor data are spectrometer sensor data, which are preferably generated by a mass spectrometer, which is used, for example, as an odor sensor. It is conceivable that this could be used to analyze the composition of a gas and/or air and/or air mixture, such as an atmosphere in a container, for example. Here, for example, the captured sensor data can indicate an intensity value curve as a function of a mass-to-charge ratio of atoms and molecules in the atmosphere.

Preferably, the capturing of the sensor data, in particular spatially resolved data, is carried out optically. Preferably, the spatially resolved sensor data are camera images.

Preferably, the sensor data relating to the container parts to be inspected are captured during the transport of these container parts to be captured in each case at an unchanged, in particular non-reduced, transport speed, i.e., while the container parts are in motion. In other words, the container parts are not slowed down and/or stopped to capture the sensor data. This offers the advantage of high throughput and production speed of the container treatment plant.

In order to visually capture the sensor data, illumination of the container parts, preferably the containers, can be provided, such as incident light and/or transmitted light illumination.

Furthermore, a real-time evaluation device, in particular a processor-based one, evaluates the (captured), in particular spatially resolved, sensor data, preferably the camera images, in real time (in particular as part of a computer-implemented method step or as a computer-implemented method step).

Here, too, the evaluation of the sensor data is preferably carried out individually for each container part, i.e., in particular separately in relation to individual container parts.

According to the invention, a set of container part features is and/or will be specified and/or provided to the real-time evaluation device and is a set of container part features extracted automatically, in particular by a neural network, as part of a machine learning method performed with regard to a training container inspection task. Preferably, the training container inspection task is different from the container inspection task. The container part features are preferably extracted using a machine learning method or by performing a machine learning method that is carried out in relation to a training container inspection task. The purpose of implementing the machine learning method is to obtain a (trained) algorithm or a (trained) model (of machine learning) which serves to fulfill or carry out the training container inspection task.

Preferably, the set of extracted container part features is a set of (extracted) container part features (automatically) extracted as part of the machine learning method carried out in relation to the training container inspection task.

The provided set of container part features is preferably received by transmission from a server which is external (with respect to the container treatment plant or operator of the container treatment plant) and/or an external memory device (such as a manufacturer of the container treatment plant). The transmission takes place at least in part via non-private communication connections.

Furthermore, the real-time evaluation device performs the container inspection task based on the predetermined set of container part features (as part of a computer-implemented method step). The real-time evaluation device preferably evaluates the sensor data captured with respect to (preferably exactly) one container part to be inspected on the basis of the predetermined set of container part features.

Preferably, the real-time evaluation device determines, depending on the predetermined and/or provided set of container part features, whether (at least) one of these container part features is depicted or shown (with a predetermined probability) in the sensor data.

Preferably, the real-time evaluation device determines, depending on the evaluation/assessment, an inspection result for the container inspection task to be performed. Preferably, depending on the inspection result determined, a control and/or regulation of at least one treatment and/or production process of the container treatment plant is carried out. It is conceivable that, depending on the inspection result (e.g., from the container treatment plant and/or a treatment device), it is determined whether the inspected container part is to be discharged. Preferably, a discharge is carried out for a part of the container that is assessed as needing to be discharged.

Preferably, the at least one sensor device and the real-time evaluation device are components of a container inspection apparatus (described in more detail below) (for a/the container treatment plant).

A (respective) sensor device can capture sensor data after each treatment step in order to check the treatment result. For this purpose, the container treatment plant can have a plurality of such sensor devices.

In other words, it is proposed to use a set of extracted container part features obtained by AI-based feature extraction for (at least) one container inspection task that was not considered in the AI-based feature extraction. While the AI-based feature extraction was carried out during or as part of a machine learning method for performing the training container inspection task and thus specifies the most essential features for the training container inspection task, no own specific feature extraction is performed for the container inspection task, but the set of extracted container part features obtained for the training container inspection task is used when performing the container inspection task.

This offers the advantage that by avoiding a new feature analysis, a time- and resource-saving procedure is obtained which can be quickly adapted to new/changed container inspection tasks. The set of extracted features obtained in a complex machine-learning-based preliminary step can advantageously achieve a high inspection performance at the same time.

In particular, the extracted container part features are not predetermined features, nor are they a selection of predetermined features (e.g., by a user). The extracted container part features are in particular abstract features which indicate or are characteristic of a light-dark contrast, a characteristic variable of a frequency of straight lines (such as how many straight lines), a brightness or a brightness gradient, shapes of contour (lines) and/or boundary lines, corners, shapes, numbers of corners, curvatures, combinations thereof and the like.

Preferably, the (in particular all) container part features are generated automatically, preferably as part of the machine learning method (and in particular not selected).

Preferably, the set of extracted container part features is not adapted and/or changed, even when a container inspection task (which is new and/or additional and/or to be adapted) is set.

It is conceivable that a number of the container part features of the set of container part features extracted or to be extracted will be and/or is predetermined, for example by a user of the container treatment plant.

Preferably, the predetermined number of container part features is taken into account when determining the set of container part features to be extracted. This predetermined number of container part features can be transmitted, for example, by the user of the container treatment plant to an external server, which determines the set of container part features to be extracted. However, it is also conceivable that the number of container part features is/will be predetermined by a manufacturer of the container treatment plant and, in particular, cannot be influenced by the container treatment plant (or by an operator thereof).

Preferably, a change and/or adaptation of a container inspection task and/or an addition of a further container inspection task takes place without changing the set of extracted container part features, wherein the (further) container inspection task is performed on the basis of the (unchanged) set of extracted container part features.

Preferably, the set of extracted container part features is and/or will be stored in the container inspection apparatus and/or in the real-time image evaluation device in such a way that it cannot be changed (even if a container inspection task is changed and/or added).

The container inspection task is in particular an inspection task relating to a container part, in particular a classification task, for example an image classification task, relating to a container part. Further possible examples in which the proposed method has proven advantageous are given in a subsequent section.

Preferably, the image classification task is solved by a combination of the two methods described in the introductory description. The feature extraction is carried out by a neural network that has been pre-trained with extensive data for similar image classification tasks. However, in the final step of evaluating the extracted features, a classical classification method is then applied.

The proposed method offers the following advantages:

A classical classification method allows rapid adaptation to new conditions within seconds directly on the machine, and without extensive training data. Adaptation to a new bottle type can be learned from just a single image of the new type.

The feature extraction, which is complex to train, preferably with the help of a neural network, is reused and therefore no longer needs to be adapted.

In a preferred method, the set of container part features is a set of extracted container part features as part of a supervised learning method. Preferably, a set of training data is used to carry out the supervised learning method, which includes sensor data relating to container parts that are labeled or marked with an inspection result of the predetermined training container inspection task to be obtained in each case.

In a further preferred method, the supervised learning method is a K-nearest neighbor algorithm (also abbreviated as “k-NN” or “KNN”). This is advantageously a simple algorithm that can be easily adapted to newly added training patterns. The K-nearest neighbors algorithm only requires a k-value and a distance metric, which is little compared to other machine learning algorithms.

In a further preferred method, a traditional machine learning algorithm is used (as a learning method), such as decision trees (decision tree learning, wherein a decision tree is a non-parametric, supervised learning algorithm with preferably a hierarchical, tree-like structure, which is used, for example, for both classification and regression tasks), random forests or random decision forest, logistic regression, k-means clustering, support vector machines (SVM).

In a further preferred method, a plurality of further (new and/or adapted) container inspection tasks, which are different from one another (in particular in pairs), can be defined and/or predetermined, in particular specific to each user, in the real-time evaluation device, wherein each of these container inspection tasks is performed on the basis of the (same) set of (extracted) container part features provided and/or predetermined to the real-time evaluation device in the machine learning method (in particular for the training container inspection task).

This offers the advantage that only a single training process or a single machine learning procedure is performed, namely the training process or machine learning procedure performed as part of the training container inspection task. The extracted container part features obtained here are then used for other container inspection tasks.

For example, the extracted feature vectors of a bottle in a (camera) image can be used in several inspection tasks/classifications.

### Example of Two Inspection Tasks/Classifications

1. Do the feature vectors show a brown bottle?
2. Do the feature vectors show a closed bottle?

Both can be seen in an image and thus also in the extracted feature vector. In the first case, the machine learning algorithm, such as kNN, is then “trained” with feature vectors of brown bottles and bottles of other colors. In the second case, with feature vectors of closed and open bottles. The features only need to be extracted once from each image.

In a further preferred method, the real-time evaluation device, in particular when a user-specific setting has been made, performs for the sensor data captured with respect to each individual container part both the training container inspection task and the container inspection task.

In other words, the real-time evaluation device can perform both the training container inspection task for which a machine learning method was performed and a hereof different container inspection task which was not taken into account in the machine learning method, but the execution of which is also based on results obtained in the machine learning method (namely the set of extracted container part features).

Preferably, an operator of the container treatment plant can set whether the training container inspection method and/or the container inspection method should be performed. It is also conceivable that both methods are performed simultaneously (by the real-time evaluation device).

In a further preferred method, a classification task with respect to, in particular precisely, one reference container part is defined as the container inspection task to be performed, wherein reference sensor data relating to the reference container part are provided to the real-time evaluation device for defining the classification task, wherein the (defined) classification task is carried out on the basis of the provided set of extracted container part features. In other words, a (new/adapted) container inspection task is defined based on the provided set of extracted container part features. This makes it advantageous to determine a container inspection task at very short notice.

In a further preferred method, the container inspection task and/or classification task to be performed is defined with respect to reference sensor data for fewer than 100 reference container parts, preferably fewer than 50 reference container parts and particularly preferably fewer than 5 reference container parts. This offers the advantage, particularly in comparison to a complex training process or machine learning method, in which a very large number of sensor data relating to reference container parts is required for a high inspection performance of the learned container inspection task, that only sensor data relating to an extremely small number of reference container parts are required. This also leads to a quick setup of a new container inspection task, for example to detect a new bottle type.

In a further preferred method, in order to determine the container inspection task to be performed, the reference sensor data relating to the reference container part or a plurality of reference sensor data relating to a plurality of reference container parts are transmitted to the real-time evaluation device via a human-machine interface. For example, an image of a new container type can be quickly transmitted, with respect to which the (new) container inspection task is to be performed based on the set of extracted container part features.

In a further preferred method, the container inspection task to be performed is determined, in particular without interruption, during ongoing working mode of the container treatment plant and/or inspection operation of the container inspection apparatus.

In a further preferred method, the container inspection task to be performed is determined without a (further) training step of a machine learning method.

In a further preferred method, a feature space is formed, which is spanned by the set of extracted container part features provided.

Preferably, a distance metric is provided with respect to the feature space, wherein the real-time evaluation device evaluates the, in particular spatially resolved, sensor data by the distance metric.

Preferably, a distance metric is provided with respect to the feature space, wherein additionally or alternatively the real-time evaluation device uses the distance metric as a measure of the similarity between sensor data, in particular spatially resolved sensor data, of different container parts and preferably different containers and/or as a measure of the similarity between sensor data captured and reference sensor data (for example, predetermined when specifying the container inspection task).

Preferably (when performing the container inspection task) a similarity between captured, in particular spatially resolved, sensor data of one container part and those of another container part (e.g., predetermined as reference sensor data) is assessed by the distance metric.

Preferably, a feature vector is created for all captured (in particular spatially resolved) sensor data, for example for each captured camera image, based on the set of extracted container part features. The feature vector can, for example, be a 256-dimensional vector.

Preferably, the feature vector has a maximum of 512 dimensions, preferably a maximum of 256 dimensions, and particularly preferably a maximum of 128 dimensions. Preferably, the feature vector has at least 16, preferably at least 32, preferably at least 64 and particularly preferably at least 128 dimensions. In principle, however, feature vectors with more than 512 dimensions or a feature space with correspondingly higher dimensionality could also be used.

Preferably, when performing the container inspection task, the distance between the feature vector of sensor data captured with respect to a first container part and the feature vector of the sensor data captured with respect to a further container part can be determined by the distance vector.

Preferably, when performing the container inspection task, the distance of the feature vector of sensor data captured with respect to a first container part and a feature vector determined with respect to reference sensor data can be determined by the distance metric.

In this way, the distance metric can be used to determine the feature vectors (and thus the corresponding captured sensor data) that were/are most similar to a given feature vector.

Preferably, feature vectors (and thus the correspondingly captured sensor data) are determined with the smallest possible distance from predetermined feature vector with respect to the predetermined distance metric.

However, it is also conceivable that the feature vector or those feature vectors (and thus the correspondingly captured sensor data) are determined which, with respect to the predetermined distance metric, have the greatest possible (or the greatest) distance to predetermined feature vectors and/or to the feature vectors of previously captured (or in a certain period of time) sensor data and/or average and/or frequent feature vectors. In this way, it is possible to identify very rarely occurring sensor data (e.g., with a very rarely occurring defect and/or with a rarely occurring container part type).

In a further preferred method, a Euclidean metric and/or a cosine similarity is used in the feature space as the distance metric. Cosine similarity (also known as cosine distance) is a measure of the similarity between two vectors, which determines the cosine of the angle between the two vectors. In particular, cosine similarity can be understood as a measure of how strongly two vectors point in the same direction. The cosine similarity between two vectors a and b can be calculated in particular from the standard scalar product of the vectors a and b, divided by the Euclidean norm of a and the Euclidean norm of b, thus: Cosine similarity=(a·b)/(∥a∥∥b∥).

In a further preferred method, the container inspection task is a classification task which is selected from a group of classification tasks which comprise a (preferably binary) classification into defective and/or defect-free container parts and preferably containers (good/bad containers), a detection and/or classification of types of defects of the container part and preferably of the container, a detection and/or classification of different types of the container part and preferably of the container (for example, ten different bottle types), a detection and/or classification of a contour and/or color of the container part and preferably of the container, a detection and/or classification of a fault-free and/or faulty execution of at least one treatment step carried out on the inspected container part, in particular by the (first) treatment device, an identification of container part types and/or types of defects which occur comparatively rarely in the container part stream (“rare” means in particular less than 1/1000), a label check, a fill level check, a check of the foaming behavior of a liquid in a container, a detection of a hairline crack and/or mouth break of a container and/or break in a bottom area of the container, a detection of foreign particles arranged or located in or on the container part and/or container, and the like as well as combinations thereof.

The working mode is preferably a continuous (production) operating mode of the container inspection apparatus and/or a continuous (production) operating mode of a container treatment plant, such as a container filling plant, which comprises the container inspection apparatus. In particular, the working mode may be a production mode. In particular, the working mode is not a test mode and/or maintenance mode and/or setting mode with a transport speed of the containers or container parts (as they pass through the container inspection apparatus) that is lower than a transport speed during an operating mode, for example.

The sensor device is preferably selected from a group comprising an image capturing device, such as a camera (preferably black and white and/or color), a CMOS sensor (CMOS is an abbreviation for complementary metal-oxide-semiconductor), a CCD sensor, a 3D sensor, an X-ray-based image capturing device, an optical element, a thermal imaging camera, a stereo camera, a LIDAR camera, an odor sensor and/or a (mass) spectrometer, and the like, and combinations thereof.

In a preferred embodiment, the transport device transports the containers from a first treatment device to a further (or second) treatment device (and/or is in particular suitable and intended for this purpose).

Preferably, the first and/or the further treatment device is selected from a group comprising an injection molding apparatus for producing an injection molded part (such as a preform), a cleaning apparatus for cleaning the containers and/or container parts, a comminution device for comminution of the containers, a filling apparatus for filling the containers, a forming apparatus for forming a plastic preform into a plastic container, in particular a blow molding machine, a closing device for closing the containers, a labeling apparatus, a marking device, a sorting device, a packaging device, a determination device for determining the composition of substances or mixtures of substances, such as the atmosphere and/or air in or on a container part and preferably container, for example a mass spectrometer and/or an odor sensor device, and the like, as well as combinations thereof.

Preferably, the container part stream is an (in particular continuous) stream (on the transport path) of successive or consecutive container parts. For example, the container part stream may be a container stream, specifically a stream of successive or consecutive containers (on the transport path). The container part stream can be guided or transported in a single lane or in multiple lanes (by the transport device) in certain regions, preferably within the entire container inspection apparatus (as a mass flow). At least one sensor device is preferably assigned to each lane of the container part stream and detects each container part of the container part stream in this lane.

The transport device can also be a mass transporter for transporting a plurality of container parts, preferably containers, preferably in several lanes and/or unorganized. The transport device can also be a buffer region for buffering, preferably in several lanes and/or unorganized, a plurality of container parts, preferably containers.

The container parts, preferably the containers, can be transported or guided (by the transport device) standing up or upright, preferably at least in regions, preferably along the entire transport region.

Preferably, the transport device is suitable and intended for at least partially guiding or transporting the plurality of container parts, preferably containers, preferably along the entire transport region, of container parts, preferably containers, that are under dynamic pressure.

Preferably, the transport device is suitable and intended for transporting and/or guiding (at least within the transport area) at least 1 container part (and preferably at least one container) per hour, preferably at least 5,000 (in particular to be inspected) container parts (and preferably containers) per hour, preferably at least 20,000 (in particular to be inspected) container parts (and preferably containers) per hour, preferably at least 100,000 (in particular to be inspected) container parts (and preferably containers), preferably at least 140,000 (in particular to be inspected) container parts (and preferably containers) and particularly preferably at least 180,000 (in particular to be inspected) container parts (and preferably containers) and carries out this within the working mode of the treatment device and/or container treatment plant. Preferably, the transport device is suitable and intended for transporting and/or guiding (at least within the transport region) a maximum of 180,000 (particularly preferably a maximum of 200,000), container parts (and preferably containers) per hour, in particular to be inspected, and carries this out during the working mode of the treatment device and/or the container treatment plant and/or the container inspection apparatus.

Preferably, in a single-lane transport region, the transport device is suitable and intended for transporting and/or guiding (at least within the single-lane transport region) at least 100,000 container parts (and preferably containers) per hour and/or up to 180,000 (particularly preferably at most 200,000) container parts (and preferably containers) per hour and carries this out during the working mode of the treatment device and/or the container treatment plant and/or the container inspection apparatus.

The containers may be preforms from which fully formed containers are produced by a forming process and/or which have so far only been produced by a primary forming step. The containers can also be already fully formed containers which have reached their final shape, for example, through a forming process of a preform (such as an injection-molded part or a molded part).

The containers may be empty, or they may be containers that are still to be filled and/or recycled and/or refilled. The containers can also be filled containers. Additionally or alternatively, the containers may be closed and/or closable using (in particular precisely) one container closure.

The containers may be disposable containers or reusable containers.

The containers preferably are (preferably sealed), in particular closable, containers for holding liquids and/or flowable substances, such as pasty and/or cream-like and/or gel-like substances, such as those from the food sector, the cosmetics industry or the pharmaceutical sector.

It is also conceivable that the containers are containers for holding liquids and/or bodies, such as containers for contact lenses.

The external memory device is preferably a cloud-based (preferably non-volatile) memory device and/or an external server (including memory device), wherein the memory device is accessed in particular via the Internet (and/or via a public and/or private network, in particular at least in sections wired and/or wireless). An external server is particularly an external server, in particular a backend server, in relation to a container inspection apparatus and/or real-time evaluation device and/or setting device.

The external server is, for example, a backend, in particular of a container inspection apparatus manufacturer or a service provider, which is configured to manage spatially resolved sensor data (in particular from a plurality of sensor devices and/or a plurality of container inspection apparatuses) and/or to carry out machine learning methods for (training) container inspection methods to be carried out and/or to adjust and/or adapt container inspection apparatuses. The functions of the backend or the external server can be carried out in (external) server farms. The (external) server can be a distributed system.

The present invention is further directed to a container inspection apparatus for a container treatment plant for treating a plurality of container parts for containers and preferably for plastic containers and/or bottles. The container inspection apparatus serves to perform a container inspection task in the container treatment plant or is suitable and intended for this purpose.

In this case, a transport device is provided in the container treatment plant for transporting the plurality of container parts as a container part stream along a predetermined transport path from at least one treatment device of the container treatment plant to at least one further treatment device of the container treatment plant.

The container inspection apparatus has at least one sensor device for performing the container inspection task, which is suitable and intended for, preferably optical, detection, in particular spatially resolved, sensor data and preferably camera images with respect to the container parts to be inspected.

Furthermore, the container inspection apparatus has a real-time evaluation device for evaluating the, in particular spatially resolved, sensor data and preferably camera images in real time.

According to the invention, a set of container part features is predetermined and/or can be predetermined to the real-time evaluation device and is a set of container part features extracted automatically, in particular by a neural network, as part of a machine learning method performed with regard to a training container inspection task. Preferably, the training container inspection task is different from the container inspection task. The container part features are preferably extracted using a machine learning method or by performing a machine learning method that is carried out in relation to a training container inspection task. The purpose of implementing the machine learning method is to obtain a (trained) algorithm or a (trained) model (of machine learning) which serves to fulfill or carry out the training container inspection task.

Preferably, the set of extracted container part features is a set of (extracted) container part features (automatically) extracted as part of the machine learning method carried out in relation to the training container inspection task.

Furthermore, the real-time evaluation device is suitable, determined and/or configured to perform the container inspection task based on the predetermined set of container part features.

It is therefore also proposed within the scope of the invention that the real-time evaluation device with the provided (extracted) set of extracted container part features is provided with AI-based, but at the same time flexibly adaptable evaluation means for evaluating sensor data.

The container inspection apparatus is preferably configured, suitable and/or determined to perform the method described above for performing a container inspection task as well as all the method steps already described above in connection with the method, either individually or in combination with one another. Conversely, the method may be provided with any of the features described for the container inspection apparatus, either individually or in combination with one another.

The present invention is further directed to a method, in particular a computer-implemented method, for determining, in particular for feature extraction, a set of container part features for use in a container inspection apparatus for performing a container inspection task, comprising the steps:
providing a training container inspection task;
providing a training data set comprising a plurality of sensor data relating to a plurality of container parts for containers and each comprising a label indicating an intended result of the training container inspection task;
performing a, preferably supervised, machine learning method, on the basis of the training data set with regard to the training container inspection task;
extracting the container part features obtained in the machine learning method. Feature extraction can be performed by the machine learning method algorithm as the first processing stage. It represents an advantageous way to significantly improve processing efficiency and reduce the influence of irrelevant information. The feature extraction is learned automatically during the training phase of the machine learning method.

The machine learning method can be carried out by an (in particular deep) neural network, such as a “convolutional neural network” (CNN). These automatically learn during the entire training process (e.g., in a computer vision process as a container inspection task) to extract meaningful features, such as edges, shapes and textures from (raw) sensor data.

In a preferred method, the training process or the machine learning method utilizes training data comprising a plurality of sensor data (of containers), in particular spatially resolved sensor data, captured by the at least one sensor device. This offers the advantage that the training process is already specifically adapted to the container inspection apparatus to be set and, for example, specific conditions of the specific container inspection apparatus, such as optical properties of the sensor device or also specific lighting conditions in the container inspection apparatus, can be taken into account directly.

Preferably, the, in particular spatially resolved, sensor data (captured by the at least one sensor device) intended for use as training data are/will be provided with (container) type and/or classification features (depending on the classification task, e.g., classification of the type of defect). Preferably, the sensor data, in particular the spatially resolved sensor data, together with the (container) type and/or classification features assigned thereto are deposited as a training data set (in particular on the external and/or non-volatile memory device). A plurality of training data sets is preferably generated in this way. The classification features can be the classes of the training container inspection task (or result classes for the container inspection tasks described above). For example, it is possible to classify the, in particular spatially resolved, sensor data assigned to a container part with the types of defects and the like that occur therein.

The non-volatile memory device may be a memory device which is an (integral) part of the at least one sensor device and/or the container inspection apparatus. It is conceivable that this memory device is a ring buffer in which the oldest sensor data are overwritten when the storage capacity is reached (and thus the stored sensor data are only available for a limited period of time).

The non-volatile memory device may also be a memory device of the container treatment plant, which is configured as a read-only memory.

“Non-volatile” can also mean that the selected images or sensor data and/or the sensor data stored on the non-volatile memory device are only held for a certain period of time, i.e., they are or can be deleted after a settable amount of time or parameterization action (installer). “Non-volatile” can also mean that the images or sensor data do not need to be held or stored after the machine has been switched off.

“Non-volatile” is also intended to mean that the image data to be “held” and/or the sensor data to be deposited must, in the simplest case, be available for parameterization.

It is also conceivable that, in addition or alternatively, “non-volatile memory device” is understood to mean that the image data to be “held” and/or the sensor data to be stored are retained even when the memory device is not supplied with power.

Training the networks requires a number of marked and/or classified sensor data (e.g., images) per application of from 1,000 to 100,000 (e.g., 10,000 marked and/or classified images per application). This marking and/or classification can be carried out locally or centrally by image processing experts.

It is (additionally or alternatively) preferable for the training data used to (preferably exclusively) be sensor data, in particular spatially resolved sensor data, of containers parts (or data derived therefrom), which were captured by a sensor device of (at least) one other, preferably identical in construction, container inspection apparatus (preferably from the same manufacturer). This offers the advantage that a plurality of sensor data can be provided and used even before the container inspection plant is started up.

It is also conceivable that the training data used are spatially resolved sensor data (or data derived therefrom) generated (exclusively or partially) synthetically or generated via augmentation (data augmentation). This offers the advantage that approximately rarely occurring classes of defect types can be simulated and the machine learning model can be trained efficiently.

The training or machine learning method is preferably carried out using supervised learning. However, it would also be possible to train the machine learning method by unsupervised learning, reinforcement learning, or stochastic learning.

Preferably, the extracted container part features are provided and/or transmitted to a container inspection apparatus or a real-time evaluation device of a container inspection apparatus (as described above).

Preferably, the method is performed on a server external to the container treatment plant and/or the set of extracted container part features is stored on a memory device external to the container treatment plant. Preferably, the deposited set of extracted container part features (after release) can be retrieved by the operator of the container treatment plant.

In an advantageous method, the number of container part features of the set of container part features to be extracted is predetermined.

The training process or the machine learning method can be carried out locally (in the container inspection apparatus) and/or centrally and/or locally independently and/or on a server external to the container inspection apparatus and/or the container treatment plant.

In an advantageous method, the machine learning method and/or the feature extraction process is/are carried out spatially separate from the container treatment plant, in particular outside the premises of the container treatment plant.

The present invention is further directed to a container treatment plant for treating container parts for containers comprising a container inspection apparatus according to a (preferred) embodiment described above and comprising a treatment device, at least one further treatment device and a transport device for transporting the container parts from the treatment device to the at least one further treatment device.

The container treatment plant is preferably configured, suitable and/or determined to perform the method described above for performing a container inspection task as well as all the method steps already described above in connection with the method, either individually or in combination with one another. Furthermore, the container treatment plant and/or the treatment device and/or the at least one further treatment device and/or the transport device can have or be equipped with at least one of the features described above, either individually or in combination with further features.

The present invention is further directed to a computer program or computer program product comprising program means, in particular a program code, which represents or encodes at least some and preferably all of the method steps of the method according to the invention and preferably one of the described preferred embodiments and is configured to be executed by a processor device.

The present invention is further directed to a data memory on which at least one embodiment of the computer program according to the invention or a preferred embodiment of the computer program is stored.

The present invention has been described with reference to a container or container parts for containers. The present invention is also transferable to injection-molded parts (molded parts) or more generally to articles to be treated in a treatment plant (such as contact lenses to be manufactured and/or packaged), the treatment progress and/or the properties and/or states (in terms of defects/quality) of which are monitored by at least one sensor device (for capturing in particular spatially resolved sensor data relating to each individual article to be inspected). The applicant reserves the right to also claim related items.

The present invention is further directed to a method for performing an article inspection task in an article treatment plant for treating a plurality of injection-molded parts and/or articles, in which a transport device transports the plurality of injection-molded parts and/or articles as an article stream along a predetermined transport path from at least one treatment device of the article treatment plant to at least one further treatment device of the article treatment plant and at least one sensor device for performing the article inspection task captures, in particular spatially resolved sensor data, preferably camera images, with regard to the injection-molded parts and/or articles to be inspected, preferably optically, and a real-time evaluation device evaluates the particularly spatially resolved sensor data, preferably the camera images, in real time.

According to the invention, a set of article features is predetermined to the real-time evaluation device, which is a set of article features extracted automatically, in particular by a neural network, as part of a machine learning method performed with respect to a training article inspection task different from the article inspection task. The real-time evaluation device performs the article inspection task based on the predetermined set of article features.

The present invention is further directed to a method for determining, in particular for feature extraction, a set of article features for use in an article inspection apparatus for performing an article inspection task, comprising the steps:
providing a training article inspection task;
providing a training data set comprising a plurality of sensor data relating to a plurality of injection-molded parts and/or articles and each comprising a label indicating an intended result of the training article inspection task;
performing a, preferably supervised, machine learning method, on the basis of the training data set with regard to the training article inspection task;
extracting the article features obtained in the machine learning method.

The present invention is further directed to an article inspection apparatus for an article treatment plant for treating a plurality of injection-molded parts and/or articles, for performing an article inspection task in the article treatment plant, wherein a transport device is provided in the article treatment plant for transporting the plurality of injection-molded parts and/or articles as an article stream along a predetermined transport path from at least one treatment device of the article treatment plant to at least one further treatment device of the article treatment plant, and wherein the article inspection apparatus has at least one sensor device for performing the article inspection task, which sensor device is suitable and intended for, preferably optical, detection of, in particular spatially resolved, sensor data and preferably camera images with regard to the injection-molded parts and/or articles to be inspected, and a real-time evaluation device for evaluating the, in particular spatially resolved, sensor data and preferably camera images in real time.

According to the invention, a set of article features is predetermined and/or can be predetermined to the real-time evaluation device, which set is a set of article features extracted automatically, in particular by a neural network, as part of a machine learning method performed with respect to a training article inspection task different from the article inspection task. The real-time evaluation device is suitable and intended to perform the article inspection task based on the predetermined set of article characteristics.

The further features described above for the container parts are correspondingly analogously applicable to the injection-molded parts and/or articles.

### BRIEF DESCRIPTION OF THE DRAWINGS

Further advantages and embodiments emerge from the accompanying drawing in which:

FIG. 1 shows a schematic representation of a container treatment plant according to the invention according to a preferred embodiment; and

FIG. 2 shows camera images illustrating the method according to a preferred embodiment of the invention.

### DETAILED DESCRIPTION OF THE INVENTION

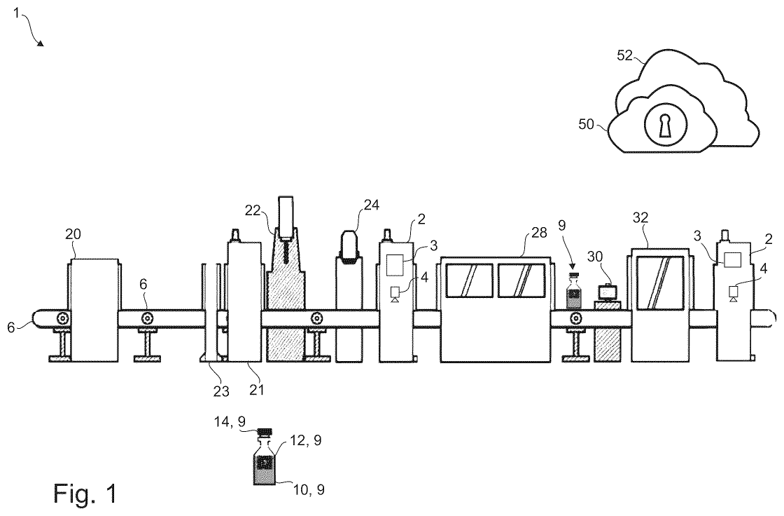

FIG. 1 shows a schematic representation of a container treatment plant according to the invention according to a preferred embodiment.

FIG. 1 shows a schematic view of a container treatment plant 1 according to a first embodiment of the invention for treating container parts 10, in this case containers 10 in the form of bottles.

Reference sign 12 denotes an equipment item arranged on the container part 10, in this case a container. In the exemplary embodiment shown in FIG. 1, an identification means is shown as an example of an equipment item and is arranged on the bottle 10. This is, for example, a (printed) QR code. Reference sign 14 designates a container closure as a further equipment item of the container 10.

In the embodiment shown in FIG. 1, a plastic preform is provided and supplied from the transport device 6 to a heating apparatus 20, heated therein and subsequently expanded in a blow molding apparatus as further treatment device, the arrangement of which within the container treatment plant 1 is indicated by the reference sign 23, to form a (plastic) bottle 10. This bottle 10 can be provided with an identification means 12 for example by the individualization device, for example a printing device, resulting in a bottle having an identification means 12.

Inside the container treatment plant 1, the container part 9 can be transported from one treatment device to the next, as well as within the treatment device(s), by at least one transport device 6. Shown here as treatment devices (in a sequence downstream of the direction of transport of the bottle) are an inspection apparatus 21, a filling apparatus 22 for filling the bottle 10 with a product, a closing apparatus 24, a drying apparatus 28, a labeling apparatus 30, and a packaging device 32 for packaging the bottle 10.

Reference sign 2 indicates a further container inspection apparatus (for example, at the end of the line and arranged between the closing device 24 and the drying device 28) in each case, which checks, for example, the fill level in the bottle and/or the proper arrangement of the closure on the bottle 10 and/or a retaining ring and/or proper labeling and/or packaging of the bottle 10 or further production data.

Reference sign 4 denotes a sensor device in each case, here a camera, by which-individually for each container part 9 (to be inspected)-sensor data relating to each container part 9 are collected or captured.

The reference sign 3 denotes in each case a real-time evaluation device by which the sensor data captured by the sensor device 4 of the respective container inspection apparatus 2 are evaluated in order to perform a (predetermined and/or fixed) container inspection task.

The proposed method uses, for analysis, a set of extracted features to evaluate the captured sensor data. The set of extracted features used is the result of a (trained) feature extraction which by a neural network that was pre-trained with (extensive) (training) data on similar image classification (inspection) tasks. However, in the final step of evaluating the extracted features, a classical classification method is then applied.

The reference sign 50 denotes an internal server or an internal memory device and the reference sign 52 denotes an external server or an external, in particular cloud-based, memory device. For example, AI-based feature extraction can be performed on the external server 52. The set of extracted container part features obtained can preferably be deposited on the external and/or internal memory device 50/52.

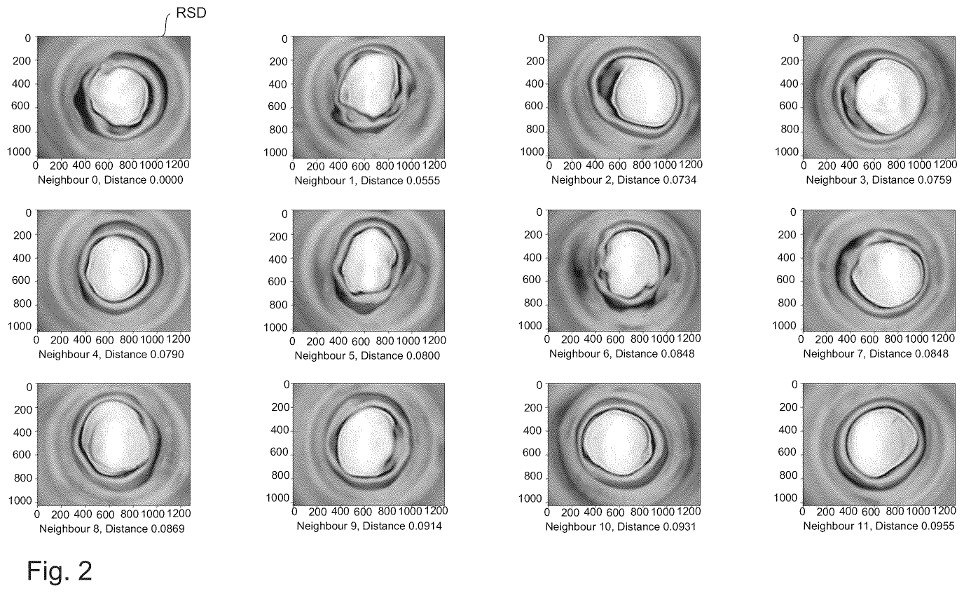

FIG. 2 shows twelve camera images to illustrate the method according to a preferred embodiment of the invention. These camera images are taken during a bottom inspection of a container by a camera that inspects the bottom of the container through the mouth of the container. The bottom is illuminated by a lighting device using a transmitted light method.

The first image, top-left in the figure plane of FIG. 2, which is indicated by the reference sign RSD, is used as the reference image. This therefore has a distance of 0 to itself, determined by a distance metric (e.g., a Euclidean one).

The further camera images shown in FIG. 2 are sorted according to the respective distance to the reference image determined with respect to the distance metric (from left to right, then from top to bottom), and thus show an increasing distance. The last camera image, located in the lower right corner of the figure, has the highest distance compared to the other camera images shown in FIG. 2 with a distance of 0.0955 and is thus the eleventh neighbor of the reference image.

The similarity of the camera images is based on the strong or less strong presence of (residual) liquid in the container being inspected.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

### LIST OF REFERENCE SIGNS

1 container treatment plant
2, 21 container inspection apparatus
3 real-time evaluation device
4 sensor device
6 transport device
10 container
9 container part
12 equipment item, direct printing element
14 equipment item, container closure
20 treatment device, here heating device
23 treatment device, here printing device
22 treatment device, here filling device
24 treatment device, here closing device
28 treatment device, here drying device
30 treatment device, here labeling device
32 treatment device, here packaging device
50 internal server, memory device
52 external server memory device

1. A method for performing a container inspection task in a container treatment plant for treating a plurality of container parts for containers, in which a transport device transports the plurality of container parts as a container part stream along a predetermined transport path from at least one treatment device of the container treatment plant to at least one further treatment device of the container treatment plant and at least one sensor device for performing the container inspection task captures sensor data relating to the container parts to be inspected and a real-time evaluation device evaluates the sensor data in real time,
wherein
a set of container part features is predetermined to the real-time evaluation device which set is a set of container part features automatically extracted as part of a machine learning method performed in relation to a training container inspection task different from the container inspection task, and in that the real-time evaluation device performs the container inspection task based on the predetermined set of container part features.

2. The method according to claim 1, wherein the set of container part features is a set of extracted container part features as part of a supervised learning method.

3. The method according to claim 1, wherein the supervised learning method is a K-nearest neighbor algorithm.

4. The method according to claim 1, wherein a plurality of further, mutually different container inspection tasks can be defined and/or predetermined in the real-time evaluation device, and wherein each of these container inspection tasks are performed on the basis of the set of extracted container part features provided to the real-time evaluation device.

5. The method according to claim 4, wherein the real-time evaluation device uses the sensor data captured with respect to each individual container part to perform both the training container inspection task and the container inspection task.

6. The method according to claim 1, wherein a classification task with respect to a reference container part is defined as the container inspection task to be performed, and wherein reference sensor data relating to the reference container part are provided to the real-time evaluation device for defining the classification task, wherein the defined classification task is performed on the basis of the provided set of extracted container part features.

7. The method according to claim 6, wherein the container inspection task and/or classification task to be performed is defined with respect to reference sensor data for fewer than 100 reference container parts.

8. The method according to claim 6, wherein in order to determine the container inspection task to be performed, the reference sensor data relating to the reference container part or a plurality of reference sensor data relating to a plurality of reference container parts are transmitted to the real-time evaluation device via a human-machine interface.

9. The method according to claim 8, wherein the container inspection task to be performed is defined during ongoing working mode of the container treatment plant.

10. The method according to claim 8, wherein the container inspection task to be performed is defined without a training step of a machine learning method.

11. The method according to claim 1, wherein a feature space is formed which is spanned by the provided set of extracted container part features, and a distance metric is provided with respect to the feature space, wherein the real-time evaluation device evaluates the sensor data by the distance metric and/or uses the distance metric as a similarity measure between sensor data of different container parts and preferably different containers.

12. The method according to claim 11, wherein a Euclidean metric and/or a cosine similarity in the feature space is used as the distance metric.

13. The method according to claim 1, wherein the container inspection task is a classification task selected from a group of classification tasks which comprises classification into defective and/or defect-free container parts, detection and/or classification of types of defects in the container part, detection and/or classification of different types of container parts, detection and/or classification of a contour and/or color of the container part, detection and/or classification of the fault-free and/or faulty execution of at least one treatment step carried out on the inspected container part, and combinations thereof.

14. A method for determining, in particular for feature extraction, a set of container part features for use in a container inspection apparatus for performing a container inspection task, comprising the steps:
providing a training container inspection task;
providing a training data set comprising a plurality of sensor data relating to a plurality of container parts for containers and each comprising in each case a label indicating an intended result of the training container inspection task;
performing a machine learning method on the basis of the training data set with regard to the training container inspection task; and
extracting the container part features obtained in the machine learning method.

15. The method according to claim 14, wherein a number of the container part features to be extracted from the set of container part features is predetermined.

16. A container inspection apparatus for a container treatment plant for treating a plurality of container parts for containers, for performing a container inspection task in the container treatment plant, wherein a transport device is provided in the container treatment plant for transporting the plurality of container parts as a container part stream along a predetermined transport path from at least one treatment device of the container treatment plant to at least one further treatment device of the container treatment plant, and wherein the container inspection apparatus has at least one sensor device for performing the container inspection task, which is configured for capturing sensor data with regard to the container parts to be inspected, and a real-time evaluation device for evaluating the sensor data in real time,
wherein
a set of container part features is predetermined and/or can be predetermined to the real-time evaluation device which set is a set of container part features automatically extracted as part of a machine learning method performed in relation to a training container inspection task different from the container inspection task, and in that the real-time evaluation device is configured to perform the container inspection task based on the predetermined set of container part features.
